(19) United States
(12) Patent Application Publication
(10) Pub. No.: US 2024/0389786 A1
(43) Pub. Date: Nov. 28, 2024

(54) A MIXING APPARATUS FOR A DRINK DISPENSING MACHINE

(71) Applicant: Koninklijke Douwe Egberts B.V., Utrecht (NL)

(72) Inventors: Koen Standaar, Utrecht (NL); Hendrik Johan Dees, Utrecht (NL)

(21) Appl. No.: 18/694,394

(22) PCT Filed: Sep. 21, 2022
(86) PCT No.: PCT/EP2022/076217

§ 371 Date: Mar. 21, 2024

(30) Foreign Application Priority Data
Sep. 21, 2021 (GB) 2113471.3

(51) Int. Cl. A47J 31/40; A47J 31/60

(52) U.S. Cl. CPC A47J 31/401; A47J 31/60

(57) ABSTRACT

This disclosure provides a mixing apparatus for mixing a powder and a fluid for use in a drink dispensing machine, the mixing apparatus comprising: a mixing chamber, wherein the mixing chamber comprises: a powder inlet; a cleaning fluid drain; a fluid inlet and a mixing chamber outlet for an outflow of mixed powder.

### TECHNICAL FIELD OF THE INVENTION

The present disclosure relates to a mixing apparatus for a drink dispensing machine. Preferably, the mixing apparatus is configured to be cleaned in situ within the drink dispensing machine.

### BACKGROUND TO THE INVENTION

Coffee dispensing machines which prepare and dispense coffee beverages are well known in the art. Many of these known machines include the option to dispense beverages which include ingredients constituting dry powders mixed with a fluid such as water or milk. Such powders may include chocolate powder or various flavoured powders. The mixing of the powders is typically done in some form of mixing chamber in which the powder and fluid are introduced and mixed to provide the deliverable product.

In order to maintain the quality of the beverages it is necessary to clean the mixing apparatus on a regular basis.

The present invention seeks to provide an improved mixing apparatus and an associated drink dispensing machine.

### SUMMARY OF THE INVENTION

The present invention provides a mixing apparatus, a drink dispensing machine and method of cleaning the mixing apparatus according to the appended claims.

The present disclosure provides a mixing apparatus for mixing a powder and a fluid for use in a drink dispensing machine, the mixing apparatus may comprise a mixing chamber comprising a powder inlet; a fluid inlet; and, a mixing chamber outlet for an outflow of mixed powder.

The mixing chamber may further comprise a drain. The drain may be a cleaning fluid drain. The cleaning fluid drain may be a high-level drain. The high-level drain may be configured to receive an overflow of cleaning fluid from the mixing chamber.

The mixing chamber outlet and/or a mixed powder outlet of the mixing apparatus may be in fluid communication with an outlet nozzle of the drink dispensing machine so as to provide the mixed powder to the outlet nozzle of the drink dispensing machine. Additionally, the mixing chamber outlet and/or a mixed powder outlet of the mixing apparatus may selectively be in fluid communication with a drain such that cleaning fluid can be drained via the mixing chamber outlet and/or mixed powder outlet. The drink dispensing machine may be selectively configurable to connect the mixing chamber outlet and/or the mixed fluid outlet to the drain or outlet nozzle depending on the function being implemented by the drink dispensing machine, i.e. a cleaning function or a beverage preparing function.

Providing a mixing apparatus with a cleaning fluid drain allows the mixing apparatus to be cleaned in situ. The cleaning fluid drain may be configured to be connected to a drainpipe or external drain of the drink dispensing apparatus.

The mixing chamber may comprise an air inlet for allowing air to enter the mixing chamber. The mixing chamber may comprise a chamber wall. The air inlet may be defined by or within the chamber wall. The air inlet may be an aperture through or partially bounded by the chamber wall.

The mixing apparatus may be located (or inserted) within the drink dispensing machine in a position in which an upper edge of the chamber wall is separated from an opposing surface of the drink dispensing machine. The separation may define the air inlet. The separation may allow the mixing apparatus to be moved relative to the mixing apparatus housing to allow installation of the mixing apparatus. The air inlet may be a restricted air flow passage for the ingress of air into the mixing chamber. The air inlet may be the only air inlet which is configured to allow air flow into the mixing chamber in use. As such, the mixing chamber may be substantially sealed except for the air inlet, the powder inlet, the mixing chamber outlet and the fluid inlet.

The mixing chamber may further comprise an exhaust for extracting air from the mixing chamber. The air inlet may be configured to replace air displaced by the exhaust. The exhaust may comprise a cleaning fluid drain. The exhaust may be in fluid communication with a source of negative pressure such as a fan.

Providing an air inlet allows an induced airflow through the mixing chamber to help extract moisture vapour from the mixing chamber and prevent egress of moisture vapour into the powder inlet and source of powder beyond. Providing an air inlet at the upper edge of the chamber wall of the mixing chamber allows the chamber wall to be as fully enclosing as possible to prevent the egress of powder whilst allowing a positive flow of air through the mixing chamber such that air can be extracted.

Providing the cleaning fluid drain within the exhaust allows the exhaust inlet to be cleaned by the cleaning flow and may reduce the number of connections required for the mixing chamber.

The mixing chamber may further comprise a chamber wall having a first base end and a second upper end. The chamber wall may comprise at least one side wall which extends upwardly between the base end and upper end. The mixing chamber outlet may be provided at the base end. The powder inlet may be provided towards the upper end. The chamber wall may comprise a base portion and a side wall portion. The side wall portion may extend from a peripheral edge of the base portion. The mixing chamber may be round in cross section and may be generally cylindrical. The base portion may be conical so as to provide a funnel having the mixing chamber outlet at the bottom thereof.

The mixing chamber outlet may be an orifice through which powder mixed with a mixing fluid can flow so as to exit the mixing chamber and mixing apparatus. In some embodiments, the mixing chamber outlet may be the mixed fluid outlet of the mixing apparatus. In other embodiments, the mixing chamber outlet may comprise or be connected to a chute (i.e. a passageway). The chute may connect to an agitator chamber which may be configured to further mix and/or froth the mixed powder prior to flowing out of the mixing apparatus. Thus, the mixing apparatus may further comprise an agitator chamber and/or an agitator. The agitator may comprise an impeller for mixing or frothing the mixed fluid.

The cleaning fluid drain may be located proximate to the powder inlet. The cleaning fluid drain may be an overflow drain and may be located at a high level. The cleaning fluid drain may comprise an aperture in the chamber wall. The aperture may provide a fluid passageway for fluid to flow through and exit the mixing chamber. The drainage aperture may be the exhaust outlet. The cleaning fluid drain may be located, with respect to the vertical orientation of the mixing chamber in use, between the powder inlet and the mixing chamber outlet. Thus, an upper portion of the mixing chamber may comprise the powder inlet with the cleaning fluid drain below the powder inlet, and the mixing chamber outlet below the cleaning fluid drain. The fluid inlet may be located vertically between the cleaning fluid drain and the mixing chamber outlet. Providing the cleaning fluid drain at high level allows the mixing chamber to be filled with cleaning fluid during a cleaning operation prior to draining off via the cleaning fluid drain.

The mixing chamber may be configured to be substantially sealed below the level of the cleaning fluid drain during a cleaning operation such that the mixing chamber is fillable with cleaning fluid from the fluid inlet. For example, the mixing chamber outlet or a connecting passageway may be configured to be closed during a cleaning operation. The cleaning fluid drain may provide an overflow drain for cleaning fluid received and retained in the mixing chamber. The overflow drain may be an open aperture in the side wall of the chamber wall. The overflow drain may be configured to allow cleaning fluid to fall under the force of gravity out of the mixing chamber. Hence, the drainpipe which attaches to the cleaning fluid outlet may provide a descending fluid passageway.

The cleaning fluid drain may be connectable to an external drain of the drink dispensing machine. The connection between the cleaning fluid drain and external drain may be provided by a drainpipe. The cleaning fluid drain and/or cleaning fluid drain drainpipe may comprise a valve for isolating the drain from the mixing chamber. The valve may be a pinch valve.

The mixing chamber outlet may comprise a chute. The chute may extend from the mixing chamber outlet and terminate in an agitation chamber. The agitation chamber may connect the mixing apparatus to the drink dispensing machine. The agitation chamber may be in fluid communication or comprise an agitator. The agitator may be an impeller. The mixing apparatus may further comprise a mixed powder outlet downstream of the mixing chamber outlet. The mixed powder outlet may be provided in the agitator chamber.

The chute may comprise a transition from a vertical flow path to a horizontal flow path. The agitation chamber may be configured to be mounted to the drink dispensing machine in the horizontal direction. The chute and/or the mixing chamber and/or the agitation chamber may comprise the mixed fluid outlet of the mixing apparatus. The mixed fluid outlet may be configured to drain fluid from the mixing chamber and/or agitation chamber. The fluid may be cleaning fluid or mixed powder fluid or mixing fluid. The mixed fluid outlet may be connectable to an external drain of the drink dispensing machine. The connection between the mixed fluid outlet and external drain may be via a passageway/pipe. The passageway/pipe may comprise a valve for isolating the mixed fluid outlet from the external drain. The valve may be a pinch valve. The external drain may be provided by an outlet nozzle of the drink dispensing machine. The mixing chamber outlet of the mixing apparatus may be referred to as a low-level cleaning fluid drain. The mixing apparatus may be provided with a separate low-level cleaning fluid drain and mixed fluid outlet in some embodiments.

The mixing apparatus may be mounted within the drink dispensing apparatus in a mixing apparatus housing.

The fluid inlet may comprise a first fluid inlet and a second fluid inlet. The first fluid inlet may be a mixing fluid inlet configured to receive a mixing fluid from the drink dispensing machine. The second fluid inlet may be the cleaning fluid inlet configured to receive a cleaning fluid flow from the drink dispensing machine. The fluid inlet may be a combined fluid inlet which is configured to receive a mixing fluid for mixing with the powder and a cleaning fluid for filling the mixing chamber during a cleaning procedure. The drink dispensing apparatus may be configured to provide the cleaning fluid or mixing fluid in accordance with a predetermined method of operation.

As noted above, the mixing apparatus may further comprise an air inlet. The air inlet may be configured to allow air to enter the mixing chamber. In particular, the air inlet may be configured to allow ingress of air to replace air displaced by an exhaust. The mixing apparatus may further comprise an exhaust for evacuating air from the mixing chamber. The exhaust may be connectable to a source of negative air pressure to provide an air flow from the air inlet to the exhaust in use. The exhaust may comprise the cleaning fluid drain.

The air inlet may be provided at the upper end of mixing chamber wall. The air inlet may be provided by a separation between the chamber wall and an opposing wall of the mixing apparatus housing of the drink dispensing machine. The inlet may be provided adjacent to the powder inlet. The powder inlet may be provided radially inwardly of the air inlet. The air inlet may be annular and may surround the powder inlet. The air inlet may be provided by a terminal end of the side wall which is distal to the base. The separation between the chamber wall and an opposing wall of the mixing apparatus housing may be between 5 mm to 0.5 mm, preferably 3 mm to 1 mm, or more preferably, 1 mm to 2 mm. The air inlet may be provided by a cut out in the chamber wall which reduces the height of the chamber wall to provide a separation between the chamber wall and the opposing wall of the mixing apparatus housing. The cut out may extend about an arc of the chamber wall. The arc may be less than 180 degrees, preferably less than 120 degrees, more preferably 90 degrees or less. The cut out may be circular. The cut out may be centred over the exhaust.

The powder inlet may be provided by an open end of the mixing chamber. The open end may be defined a terminal edge of the side wall and/or an upper wall of the chamber wall and/or an inner wall of the chamber wall.

The powder inlet and/or upper end of the chamber wall may be sealably attached to the mixing apparatus housing. The powder inlet may be configured to receive a powder inlet chute of the drink dispensing machine. The open end of the mixing chamber may be configured to receive a powder inlet chute. The powder inlet chute may be configured to be inserted into the powder inlet following insertion of the mixing apparatus into the mixing apparatus housing. The powder inlet chute may be sealably received within the powder inlet.

The fluid inlet may comprise a fluid inlet passageway which extends tangentially through the chamber wall, e.g. the side wall.

According to a further aspect of the present disclosure, there is provided a drink dispensing apparatus comprising any mixing apparatus of the present disclosure. The drink dispensing apparatus may dispense a consumable liquid for a human. The drink dispensing apparatus may dispense one or more of coffee, tea, chocolate, and/or soup. The drink dispensing apparatus may be a vending machine.

The drink dispensing machine may comprise a mixing apparatus housing in which the mixing apparatus is located. The drink dispensing apparatus may comprise a cleaning fluid source and a mixing fluid source. The drink dispensing apparatus may be configured to connect the cleaning fluid source and the mixing fluid source to the fluid inlet. The drink dispensing apparatus may comprise an external drain. The external drain may be connected or connectable to the cleaning fluid drain. The external drain may be connected or connectable to the mixed powder outlet such that the mixed powder outlet may be configured to act as a drain.

The mixing apparatus housing may comprise a plurality of ports for connecting to the inlets and outlets of the mixing apparatus. The ports may comprise one or more from the group comprising: a powder inlet port, a fluid inlet port, a cleaning fluid drain port, an exhaust port, and a mixed powder outlet port. Two or more of the ports may be configured to receive the corresponding respective inlets or outlets from a common direction. The common direction may be in the horizontal plane. The two or more ports may be provided on a common wall or in a common plane of the mixing apparatus housing. The two or more ports may comprise the fluid inlet and agitator port and, optionally, the exhaust port.

The mixing apparatus may comprise a plurality of inlets and/or outlets on the same side such that the mixing apparatus can be insertably mounted to the drink dispensing apparatus from a single direction. The fluid inlet, and optionally agitator chamber, and optionally the exhaust, may be provided on a first side of the mixing apparatus. The mixed powder outlet and/or cleaning fluid drain may be provided on a second side of the mixing apparatus. The first and second sides may be opposite to one another. The mixing apparatus may be removably mounted within the mixing apparatus housing or may be permanently fixed within the mixing apparatus housing. By removably mounted, it is meant that the mixing apparatus may be readily removed by hand by an end user rather than, for example, requiring a tool to remove one or more retaining fixings for maintenance or repair purposes.

The mixing apparatus may be mounted to the drink dispensing apparatus only by the connection provided by one or more of the inlets or outlets.

According to yet a further aspect of the present disclosure, there is provided a method of cleaning a mixing apparatus in a drink dispensing machine, comprising: filling the mixing chamber with cleaning fluid; and, allowing the cleaning fluid to drain from the cleaning fluid drain. The cleaning fluid drain may be an overflow drain. The method may further comprise draining the cleaning fluid from a mixed powder outlet and/or a low-level drain. The method may further comprise reconfiguring the mixed powder outlet so as to be connected to an external drain of the drink dispensing machine, thereby being configured as a low-level cleaning fluid drain. The method may further comprise operably inserting the mixing apparatus into the drink dispensing machine prior to use.

In one embodiment, the method of (autonomous) cleaning may comprise the closing of the outlet dock to isolate the source of dispensable fluid, so that the apparatus can go into a cleaning mode. Preferably, all sub-systems may then be flushed to remove any dispensable fluid remains from the dispensable fluid circuit. Cleaning fluid may then be dispensed into the dispensable fluid circuit. This may occur from a reservoir containing cleaning fluid. The apparatus may heat the cleaning fluid to a temperature of at least 50° C., preferably at least 60° C., preferably at least 70° C., and most preferably approximately 75° C. The apparatus may circulate the cleaning fluid through all sub-systems at the elevated temperature, for a selected time period, for example, at least 2 minutes, preferably at least 3 minutes, preferably at least 4 minutes, and more preferably at least 5 minutes. The cleaning fluid may then be drained from the dispensable fluid circuit. Preferably, all subsystems may then be flushed to remove any remaining cleaning fluid. The outlet dock may then be opened to return the apparatus to the dispensing mode.

The apparatus may be used in an intermediate rinse mode in which the outlet dock may be closed to isolate the source of dispensable fluid, so that the apparatus can go into an intermediate rinse mode. Preferably, all sub-systems may then be flushed to remove any dispensable fluid remains from the dispensable fluid circuit. After this, the outlet dock may then be opened to return the apparatus to the dispensing mode.

The skilled person will appreciate that except where mutually exclusive, a feature described in relation to any one of the aspects, embodiments or examples described herein may be applied mutatis mutandis to any other aspect, embodiment or example. Furthermore, except where mutually exclusive, any feature described herein may be applied to any aspect and/or combined with any other feature described herein.

### BRIEF DESCRIPTION OF THE DRAWINGS

In order that the invention may be more clearly understood one or more embodiments thereof will now be described, by way of example only, with reference to the accompanying drawings, of which:

FIG. 1 shows an example of a mixing apparatus for mixing a powder in a drink dispensing machine;

FIG. 2 shows a rearward view of the mixing apparatus shown in FIG. 1;

FIG. 3 shows a plan view of the mixing apparatus;

FIG. 4 shows the mixing apparatus housing and various connection ports for the mixing apparatus; and,

FIG. 5 shows a schematic representation of a drink dispensing machine which incorporates the mixing apparatus.

### DETAILED DESCRIPTION OF THE INVENTION

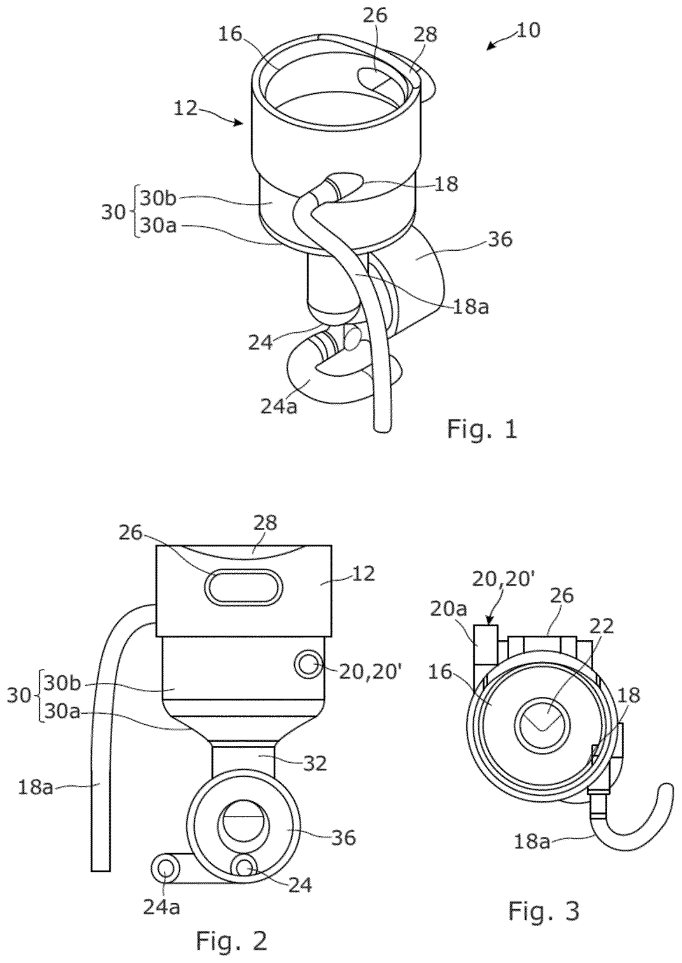

FIG. 1 shows an example of a mixing apparatus 10 housed within a mixing apparatus housing of a drink dispensing apparatus 500.

The mixing apparatus 10 of the described embodiment is for mixing a dry powder, e.g. chocolate powder or some other beverage flavouring, coffee, tea, soup, etc, and a fluid, e.g. water or milk, and is configured so as to receive a flow of cleaning fluid whilst in situ. Hence, the mixing apparatus 10 may be installed within a drink dispensing machine 500 and used in the preparation of one or more drinks (which may be referred to as beverages) whilst being cleaned without the need to be removed from the drink dispensing machine 500. Further, the mixing apparatus 10 may be cleaned without a user having to move or reconfigure the mixing apparatus 10, thereby reducing the need for manual intervention and increasing the automation of the cleaning process and convenience of the drink dispensing machine 500.

The term drink dispensing machine may be taken to be any machine used to prepare and dispensing a consumable liquid such as coffee, tea, chocolate or soup. The drink dispensing machine may be a vending machine.

The term “powder” referred to herein may comprise the term “dry edible powder” which refers to a solid powder suitable for ingestion by humans or animals. The powder may contain an amount of moisture but this will preferably be less than 10 wt %, more preferably less than 6 wt %. more preferably less than 5 wt % and most preferably less than 3 wt %. The type of dry edible powder is preferably matched to the type of beverage concentrate. The dry edible powder may comprise any suitable, preferably soluble, beverage powder, such as soluble coffee, tea, fruit, milk, creamers, chocolate, cocoa, sugars, soup ingredients, and combinations thereof. For example, when the mass is formed from a coffee extract, the dry edible powder is preferably a conventional coffee powder, such as a spray dried coffee powder having a moisture content of from 1 to 6 wt %.

The powder material may be in any form, including tablet form, and may processed by any means suitable for use in a beverage preparation machine. For example, the powder may be processed by spray drying, agglomeration, freeze drying, granulation or compaction into a soluble tablet comprising the beverage ingredient powder.

As best seen in FIGS. 1 to 4, the mixing apparatus 10 comprises a mixing chamber 12 (which may be referred to as a mixing bowl) housed within a mixing apparatus housing 14. The mixing chamber 12 may have a powder inlet 16, a cleaning fluid drain 18, a fluid inlet 20 and a mixing chamber outlet 22 for an outflow of powder mixed with fluid received from the fluid inlet 20.

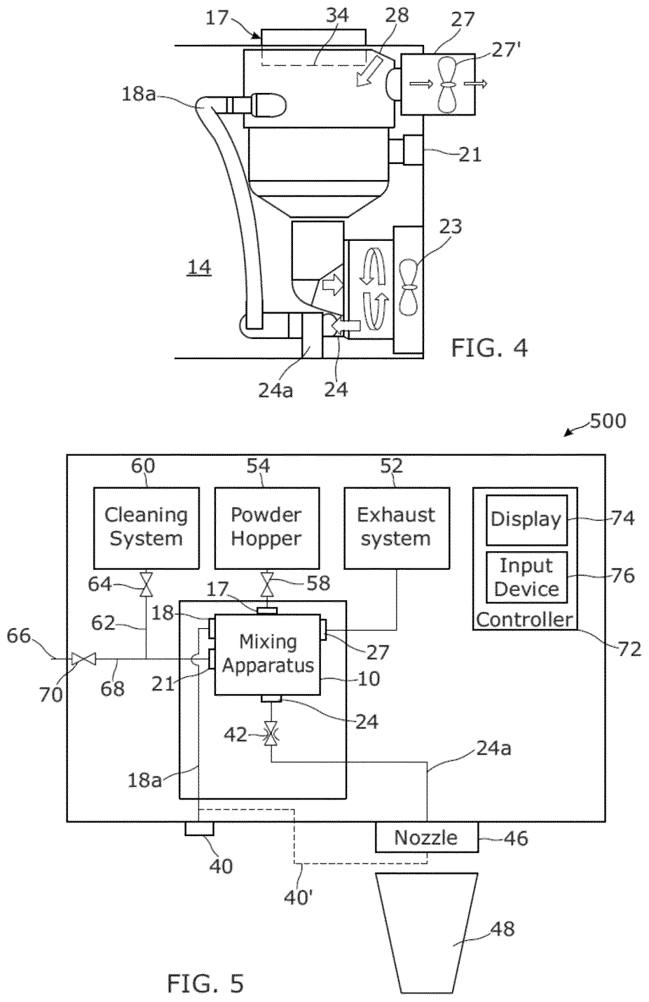

FIG. 2 shows a rearward view of mixing chamber 12 looking into an agitation chamber 36 which is in fluid communication with the mixing chamber outlet 22 of the mixing chamber 12, a mixed powder outlet 24 and an exhaust 26 and FIG. 3 shows a top down view of mixing chamber 12 showing the powder inlet 16, fluid inlet 20 and mixing chamber outlet 22 of the mixing chamber 12. FIG. 4 shows the connection of the various inlets and outlets of the mixing apparatus. Hence, there is shown an air exhaust port 27 which is coupled to the exhaust 20 and in fluid communication with a source of negative pressure such as an extractor fan 27′, an agitator 23 which is coupled to the agitator housing 36, mixed powder outlet pipe 24a, and powder inlet port 17 which may comprise a chute received within the powder inlet 16.

The fluid inlet 20 may be configured to supply a fluid for mixing with the powder and/or providing a cleaning fluid for cleaning the mixing chamber 12. In the following disclosure, the fluid inlet 20 is a combined fluid inlet 20 which is separately connectable to a source of mixing fluid and a source of cleaning fluid. In some embodiments, the cleaning fluid and mixing fluid may be the same, e.g. water. In some embodiments, there may be separate fluid inlets for the mixing fluid and cleaning fluid.

The exhaust 26 is optional and provided for venting the mixing chamber 12 during a mixing process and/or the cleaning process. An air inlet 28 may also be optionally included and configured to allow air displaced by the exhaust 26 or otherwise to enter the mixing chamber 12. Providing an exhaust 26 and air inlet 28 allows a controlled airflow through the mixing chamber, thereby minimising the escape of powder from the mixing chamber 12 and/or preventing egress of fluid (e.g. liquid or vapour) from the mixing chamber into the powder inlet port 17.

The mixed powder outlet 24 is in fluid communication with an outlet nozzle 46 of the drink dispensing machine 500. One or more drains of the mixing apparatus 10 may also comprise the mixed powder outlet 24. The mixed powder outlet 24 may allow any fluid within the mixing chamber 12 to be removed to an external drain 40 of the drink dispensing machine 500. The drained fluid may be the remanence of the mixing process or cleaning fluid. The one or more drains may also include the cleaning fluid drain 18 which is provided to drain cleaning fluid from a high level. The cleaning fluid drain 18 may be considered to be an overflow drain which drains cleaning fluid by gravity when the height of the cleaning fluid reaches the overflow.

The mixing chamber 12 may comprise a chamber wall 30 which defines an internal volume for receiving the powder from the powder inlet 16 and mixing fluid from the fluid inlet 20. The received powder and mixing fluid may be mixed within the internal volume of the chamber wall 30 before being outputted from the mixing chamber 12 as a flow of mixed powder via the mixing chamber outlet 22.

In the embodiment shown, the chamber wall 30 comprises a base portion 30a provided at a lower, first end of the mixing chamber wall 30, and an upper, second end. A side wall 30b extends from the base portion 30a towards the upper end. In the embodiment shown, the base portion 30a is tapered to provide a funnel which terminates in the mixing chamber outlet 22 in the form of an outlet chute 32 into which mixed powder can flow out of the mixing chamber 12. The chute 32 extends from the mixing chamber outlet 22 of the mixing chamber 12 to a terminal end which connects to an optional agitator 23 provided by mixing apparatus housing 14.

The outlet chute 32 is optional but advantageous as it allows the mixed powder to be received from the mixing chamber 12 and delivered to the mixed powder outlet 24 having a smaller size. The chute 32 may include a transition from vertical to horizontal, as shown. Where a chute 32 is not provided, the mixing chamber outlet 22 of the mixing chamber 12 may be directly connected to a suitably located mixed powder outlet pipe 24a or the agitation chamber 36.

The side wall 30b in the embodiment shown extends vertically upwards from a peripheral edge of the base portion 30a to a terminal end which defines the upper end of the mixing chamber 12. The side wall 30b may be exclusively vertical or may be inclined to the vertical and include various sections or portions which extend in different directions. Thus, the side wall 30b may comprise one or more curved sections when viewed in section and/or include one or more steps, tapers, and/or shoulder portions, as shown. Further, the side wall 30b and base portion 30a may be provided by a single continuous wall having a tapering profile. The angle of the taper of the base portion 30a is shown as being approximately 30 degrees in the drawings, but this is not a limitation and other angles are possible. The side wall 30b may be generally cylindrical.

The powder inlet 16 is provided at the upper end of the mixing chamber 12 by an opening which provides a powder flow path from the exterior of the mixing chamber 12 to the internal volume. The powder inlet 16 may be any suitable aperture and may be provided uppermost with respect to the mixing chamber 12. Thus, as shown, in some embodiments the upper end of the mixing chamber 12 may be open ended such that an amount of powder can be deposited into the internal volume from above, preferably under the force of gravity. The powder inlet 16 may be provided centrally in relation to the mixing chamber 12 such that a centre of the powder inlet 16 is concentric with the internal volume and/or a central longitudinal axis of the mixing chamber 12. The powder inlet 16 may be defined by the terminal end of the side wall 30b and/or by a horizontally extending upper wall portion of the chamber wall 30 and/or mixing chamber 12.

The side wall 30b of the described embodiment is shown as terminating with an upper edge which includes an optional narrowing taper. The side wall 30b also includes a cut out at the uppermost edge to provide a separation from an opposing upper wall of the mixing apparatus housing 14, thereby proving the air inlet 28 which extends about an arc of approximately 90 degrees. The cut out is shown as being curved having a constant radius when viewed from the rearwards view of FIG. 2 and being located centrally over the exhaust 26. It will be appreciated that other positions, sizes and shapes of air inlets 28 are possible. For example, the air inlet 28 may be provided by a general separation between the upper edge of the side wall 30b and the roof of the mixing chamber apparatus.

In some embodiments, the upper edge of the side wall 30b may extend inwards towards the centre of the mixing chamber 12, thereby providing the upper wall portion which overhangs and partially encloses the internal volume of the mixing chamber 12. The radially extending flange may terminate in an axially extending circumferential flange to provide an inwardly directed skirt which bounds and thereby defines the extent of the powder inlet 16. The combination of the side wall 30b, upper wall and axial flange may provide the chamber wall 30 with an inverted J-shape in section. The axially extending wall may be referred to as a mixing chamber inner wall.

The powder inlet 16 is configured to receive a quantity of powder from a powder source, such as a hopper 54, as seen in FIG. 5. As noted above, in the embodiment shown in FIGS. 2a to 2c the powder inlet 16 is located above the mixing chamber 12 and may therefore be at least partially gravity fed. Hence, once the powder is released from the hopper 54 to a point above the mixing chamber powder inlet 16, gravitational force may cause the powder to fall into the mixing chamber 12 for mixing.

The hopper 54 may be proximal to the powder inlet 16 but it will be appreciated that in some embodiments there may be an interconnecting passageway which extends between the mixing chamber 12 and a remotely located hopper 54. The hopper 54 and or the interconnecting passageway may comprise a dispensing means which extracts a required amount of powder from the hopper 54 into the mixing chamber 12.

As shown in FIG. 4, the interface between the source of powder and powder inlet 16 may comprise a powder inlet chute 34. The inlet chute 34 may be configured to direct the powder into the mixing chamber 12 and/or to mate or be received within the powder inlet 16 of the mixing chamber 12. In the embodiment shown, the powder inlet chute 34 is provided by a flange which extends inwardly (axially downwards) from the mixing apparatus housing 14 into the volume of the mixing chamber 12.

The mixing chamber 12 may be arranged to snugly receive the powder inlet chute 34 so as to minimise the escape of powder from the mixing chamber 12 during the deposition or mixing of the powder. In some embodiments the powder inlet chute 34 may be mateably received by the chamber wall 30. With the exception of the air inlet 28 (when present), the powder inlet chute 34 may be sealably received by the chamber wall 30 in some embodiments, or loosely received, thereby defining a flow passage therebetween for air to be drawn into the internal volume under the influence of negative pressure provided by the exhaust 26 and/or a degree of movement between the mixing apparatus 10 and mixing apparatus housing 14 to allow for an easier installation. It will be appreciated that the cut-out inlet shown in FIGS. 1, 2 and 4 reduces the height of the chamber wall 30 across a chord which may aid the installation of the chamber wall in use.

The mixing chamber 12 comprises a fluid inlet 20 and, as noted, the fluid may be any suitable fluid with which the powder can be mixed and could be or may comprise, for example, milk or water. In relation to the flow direction of the powder which extends from the powder inlet 16 to the mixing chamber outlet 22, the fluid inlet 20 may be arranged to provide the fluid between the powder inlet 16 and the mixing chamber outlet 22 such that the fluid and powder can converge and mix at a confluence within the internal volume. Introducing the fluid downstream of the powder allows proper mixing upstream of the mixing chamber outlet 22. The fluid inlet 20 may be provided by an opening or nozzle having a flow passage which extends through the chamber wall 30, e.g. the sidewall 30b.

To aid mixing, the fluid inlet 20 may be provided with an initial flow trajectory at an angle with respect to the powder flow path so as to provide a suitable mixing of the powder and fluid when the powder and fluid collide. The trajectory of the fluid may be orthogonal to the direction of powder flow. For example, when the powder is introduced from above and falls vertically into the internal volume of the mixing chamber 12, as shown in the described embodiment, the fluid may be introduced with a dominant horizontal component (which may be entirely horizontal). In some embodiments, as shown in FIG. 3, the fluid inlet 20 may extend tangentially into the mixing chamber 12 so as to create a circumferential flow around the side wall 30b and/or base portion 30a, thereby providing an improved mixing flow with the powder around the circumference of the mixing chamber 12. As the tangential velocity of the fluid reduces due to the mixing, the mixed powder can flow under gravity into the mixing chamber outlet 22.

Thus, as shown in FIG. 3, the fluid inlet 16 may comprise a conduit 20a which extends towards and joins the chamber wall 30 at a tangent to the circular side wall 34. The conduit 20a defines a fluid pathway which extends through the chamber wall 30 such that fluid is introduced tangentially with respect an inner surface of the chamber wall 30. The conduit 20a is provided vertically between the powder inlet 16 and mixing chamber outlet 22 and, as shown, may be above the base portion 30a.

The fluid inlet passageway provided by the conduit 20a may be configured to be received in a corresponding fluid inlet port 21 provided by the mixing apparatus housing 14 of the drink dispensing machine 500. The conduit 20a may be mated with the fluid inlet port 21 using known methods. For example, the conduit 20a may be sized to be sealably received within the fluid inlet port 21. The fluid inlet port 21 may include one or more resiliently deformable seal elements, e.g. O-rings, which slidably receive an external surface of the conduit 20a such that the mixing apparatus 10 can be easily connected to the drink dispensing machine 500 by a user without the need for the user additionally connecting (or disconnecting) the fluid inlet conduit 20a by hand.

It will be appreciated that the fluid inlet 20 will be connected to a source of fluid in use and the fluid may be under pressure as it enters the mixing chamber 12. The pressure may be provided by a mains fed water system or an internal pump, for example.

As shown, the mixing chamber outlet 22 may be provided at the lowermost point of the mixing chamber 12 and be configured to receive the mixed powder. The mixing chamber outlet 22 of the embodiment shown in FIGS. 1 and 2 comprises a tubular outlet chute 32 which transitions the mixed powder flow from a vertical trajectory to a horizontal one. Thus, the tubular outlet chute 32 comprises a first vertical portion which appends from the mixing chamber 12 and a second horizontal portion which extends from the vertical portion to an agitation chamber 36 of the mixing apparatus 10. The agitation chamber 36 may be configured to be receive or be in fluid communication with an impellor 23 which is provided in the mixing apparatus housing 14 of the drink dispensing machine 500.

The mixed powder outlet 24 may be in fluid communication with an outlet nozzle of the drink dispensing machine 500 which provides an outflow of the mixed powder to a drinking receptacle 48. As the agitation chamber 36 is at the lowest part of the mixing apparatus, it may also comprise the mixed powder outlet 24. The mixed powder outlet 24 may be configured to drain the remanence of the mixed powder, or a cleaning fluid depending on the process being carried out. The mixed powder outlet 24 may be connected to an external drain 40 via a suitable pipe such as the mixed powder outlet pipe 24a. The external drain 40 may be a dedicated drain which is plumbed into a waste system such as a container or mains drain, or may be provided by the outlet nozzle 46 which provides the drained fluid to a drip tray or temporary drain placed under the outlet nozzle during a cleaning procedure. The mixed powder outlet pipe 24a may comprise a valve 42 (see FIG. 5) which is operable to close the pipe 24a thereby allowing the mixing chamber to be filled with cleaning fluid.

The agitation chamber 36 of the embodiment shown in FIG. 1 may comprise a wider cross-sectional area than that of the mixing chamber outlet chute 32. The wider cross-sectional area allows the agitator 23 to be provided within the chamber and also allows the mixed powder outlet 24 to be accommodated within the agitation chamber 36 and be provided at the lowest point of the mixing apparatus 10.

The transition between the agitation chamber 36 and mixing chamber outlet chute 32 may be provided by a flaring of the outlet chute 32 or a step change in the relative diameters of the chute 32 and agitation chamber 36, or by a tapered section. As such, and as shown in the drawings, the outlet chute 32 may comprise a first tubular member having a first diameter, and the agitation chamber 36 may be provided by a second tubular member having a second, larger diameter. The outlet chute 32 and agitation chamber 36 may be arranged coaxially.

The agitator 23 may be configured to further mix and/or froth the mixed powder received within the agitation chamber 36, as known in the art. Further, the agitator 23 may be configured to provide a pumping action to initiate and/or force fluid out of the mixed powder outlet 24. Drainage of fluid from the outlet 24 may be achieved additionally or alternatively by gravity and/or a syphoning action.

The connection of the pipe 24a to the mixed powder outlet 24 may be provided on a portion of the mixing apparatus 10 which faces rearwards, away from the agitator chamber 36. As such, the outlet 24 may be exposed to a user following insertion of the mixing apparatus 10 within the mixing apparatus housing 14 so that the pipe 24a may be connectable to the outlet 24 once the mixing apparatus 10 has been mounted within the drink dispensing machine 500. Thus, as shown, the low-level mixed powder outlet 24 is provided on radial wall portion of the agitator chamber 36 which faces rearwards and towards a user inserting the mixing apparatus 10 into the drink dispensing machine 500.

The mixing apparatus 10 may be detachably attached to the drink dispensing machine 500. Thus, the mixing apparatus 10 may include one or more attachment features or attachment points which are used to attach the mixing apparatus 10 to the drink dispensing machine 500 (or an intermediate structure thereof). The mixing apparatus 10 shown in FIGS. 1 to 4 is provided with a plurality of attachment points, each of which are provided by the connection of one or more of the inlets or outlets of the mixing apparatus 10 to the drink dispensing machine 500. Thus, the attachment of the mixing apparatus 10 may be implemented connecting or more of the agitation chamber 36, the fluid inlet conduit 20a and the exhaust 26, with the respective corresponding ports 23, 21 and 27 provided by the apparatus housing 14. The attachments may be provided by any suitable attachment known in the art such as an interference fit, a push fit connector, a bayonet or a screw thread. Further, additional conventional mechanical attachments may be provided in some embodiments, and, in some embodiments, the mixing apparatus 10 may be permanently fixed within the drink dispensing apparatus 500.

To aid with the fitting of the mixing apparatus 10 to the drink dispensing machine 500 where the mixing apparatus 10 is detachably attached, the mixing apparatus 10 may comprise one or more handles. The handle may append from an external surface of the mixing chamber 12 and be in the form of a cantilever. The handle may be curved so as to be more readily grasped by a user's digit. It will be appreciated that other configurations of handle and/or gripping features are possible.

The fitting of the mixing apparatus 10 to the drink dispensing machine may require the powder inlet chute 34 which extends vertically, to be received within the mixing chamber 12. As such, the powder inlet chute 34 may be inserted after the mixing apparatus 10 is installed, or may need to be vertically inserted into the mixing chamber 12 prior to the insertion of connection of the various inlets and outlets which may be mated horizontally. In order to achieve this, the powder inlet chute 34 may be loosely received within the powder inlet 16 such that the mixing apparatus 10 can be suitable manipulated, e.g. swung/rotated to allow the necessary horizontal mating once the inlet chute 34 has been received.

In order to clean the mixing chamber 12 and/or mixing apparatus 10 more generally, the mixing apparatus 10 may be provided with a cleaning fluid inlet 20′ and a cleaning fluid drain 18. In doing so, the mixing chamber 12 is configured to be cleaned in situ, rather than being removed.

The cleaning fluid inlet 20′ may be any suitable inlet through which a suitable cleaning fluid can be received. The cleaning fluid may be hot or cold water, or steam, and may include one or more cleaning agents such as a detergent, for example.

In the embodiment shown, the cleaning fluid inlet 20′ is provided by the fluid inlet 20 which is used to provide the fluid for mixing with the powder. Hence, the cleaning fluid may be water which is the same as used for the mixing with the powder. Alternatively, the drink dispensing machine 500 may be configured to connect the fluid inlet 20, 20′ to alternative sources of fluid, depending on the use in any given instance. For example, the fluid inlet 20 may be connected to a source of cold water for mixing with the powder when preparing a beverage, and connected to a source of cleaning fluid for cleaning apparatus. It will be appreciated that the pipework upstream of the fluid inlet 20, 20′ may comprise any suitable combination of pipework and/or valves required to implement the connection of the mixing fluid and cleaning fluid to the mixing apparatus 10.

As noted, the mixing apparatus 10 may have one or more drains for receiving an outflow of spent cleaning fluid. The drain may be the aforementioned low-level mixed powder outlet 24 or an equivalent which is located, for example, below the mixed powder flow path. Additionally or alternatively, drain may be provided by the cleaning fluid drain 18.

The cleaning fluid drain 18 of the embodiment is located towards an upper end of the mixing chamber 12 such that the mixing chamber 12 can be filled with a cleaning fluid prior to reaching the high level cleaning fluid drain 18, which is configured to act as an overflow. As such, in use, the mixing chamber 12 can receive a cleaning agent from the cleaning fluid inlet 20′ so as to fill the mixing chamber until part of the cleaning fluid drain 18 is submerged. A continuous flow of cleaning fluid may be passed through the mixing chamber 12 and out of the cleaning fluid drain 18 for a predetermined period of time such that the appropriate level of cleanliness can be achieved. Following this, the supply of cleaning fluid flow can be stopped, and the low-level mixed powder outlet 24 opened to allow the mixing chamber 12 and mixing apparatus more generally, to be drained of cleaning fluid. The mixing apparatus 10 may be additionally flushed with clean water following a cleaning cycle.

The cleaning fluid drain 18 (which may be referred to as an overflow drain) may be provided proximate to the powder inlet 16 such that the cleaning fluid is provided as close to the source of powder and cover as much of the area which may be contaminated with powder as possible. In the embodiment shown in FIG. 1, the cleaning fluid drain 18 is provided proximal to the upper end of the mixing chamber 12 by an aperture through the side wall 30b of the mixing chamber 12. As such, as can be seen, the mixing apparatus 10 may therefore comprise, in a powder flow (vertical) direction: a powder inlet; a cleaning fluid drain; a cleaning fluid inlet; and a mixing chamber outlet. As noted above, an agitator 23 and agitation chamber 36 may be provided in the downstream flow path.

As with the mixed powder outlet 24, the overflow drain 18 may be connected to a drain via one or more passageways, such as a drainpipe 18a, which connects to an external drain 40 of the drink dispensing machine 500. The drainpipe 18a may comprise a valve which is operable to prevent egress or ingress of fluid into the mixing chamber 12 when required or may be permanently open. When used, the valve may be pinch valve which is configured to compress the drainpipe 18a to prevent a flow of fluid or, optionally, gas therethrough. Either or both of the cleaning fluid drain 18 or external drain 40, or the associated pipework, may comprise the isolation valve. In some embodiments, the pipe 24a and the drainpipe 18a may be combined so as to be provided by a common drainpipe downstream of the mixing apparatus 10.

In order to prevent the passage of water vapour into the powder hopper 54 and to help prevent the unintentional egress of powder from the mixing apparatus 10 into the surrounding mixing apparatus housing 14, the mixing apparatus 10 may comprise an exhaust 26 and an air inlet 28. The exhaust 26 may be attached to or at least be in fluid communication with a source of negative pressure, such as a fan 27′, which may be provided by an exhaust system 52 of the drink dispensing machine 500. As such, when the source of negative pressure is operated, air, moisture, and/or powder, can be extracted from the interior of the mixing chamber 12 to a suitable external vent.

In order to create the necessary air flow and to prevent air being drawn through the powder hopper 54, the mixing apparatus 10 may comprise the air inlet 28. The air inlet 28 may be any suitable structure or aperture through which air can be drawn when the mixing chamber 12 is being evacuated. As described above, the air inlet 28 is provided by a separation between the terminal end of the mixing chamber wall 30 and an opposing wall of the mixing apparatus housing 14 by a cut out. However, the separation may be an annular separation which extends fully around the terminal edge of the chamber wall 30, or may be provided by one or more apertures in the chamber wall 30. The one or more apertures may be provided through the chamber wall 30 or between the upper most edge of the chamber wall 30 and opposing wall of the mixing apparatus housing 14. For example, the side wall 30b may comprise a plurality of castellations or notches to provide intermittent separation between the side wall 30b and housing 14.

The exhaust 26 may be provided beneath the powder inlet 16 and below any chute or flanges which extend into the mixing chamber 12. The exhaust 16 may be provided above the cleaning fluid drain 18 so that cleaning fluid does not enter the exhaust 26. However, in some embodiments, the cleaning fluid may enter the exhaust 26, which may optionally provide the cleaning fluid drain 18.

The size of the separation between the upper edge of the chamber wall 30 and opposing wall of the mixing apparatus housing 14 may be in the order of millimetres so as to provide the necessary air inlet and/or freedom of movement for installing or removing the mixing apparatus 10. In some embodiments, the separation between the chamber wall and an opposing wall of the mixing apparatus housing 14 may be between 5 mm to 0.5 mm, preferably 3 mm to 1 mm, or more preferably, 1 mm to 2 mm.

As shown in FIG. 4, the mixing apparatus housing 14 may comprise a number of ports which correspond to the various inlets and outlets of the mixing apparatus 10. Thus, in the embodiment shown in FIG. 4, there is provided a powder inlet port 17, a fluid inlet port 21, an agitator 23 and an air exhaust port 27. It will be appreciated that the powder inlet port 17 may comprise the powder inlet chute 34 described above. As noted above, the mixed powder outlet 24 and overflow drain 18 are connected via separate pipes 18a, 24a, however, there could be corresponding ports provide in the wall of the mixing apparatus housing 14 in some embodiments.

Two or more of the ports may be provided in a common plane or face in a common direction such that the mixing apparatus 10 may be insertably attached to the ports from a single direction. Hence, as shown in FIG. 5, a plurality of ports, namely the fluid inlet port 21, agitator 23 and air exhaust port 27 are all provided on a common wall of the mixing apparatus housing 14. The agitator 23 and exhaust port 27 may be provided directly vertically one above the other. The fluid inlet port 21 may be offset to one side of the agitator 23 and exhaust port 27 to allow for the tangential connection of the fluid inlet conduit 20a to the mixing chamber 12. In accordance with the above, the mixing apparatus 10 may be arranged to provide a plurality of connections on the same side. Thus, as can be seen in FIG. 4, the fluid inlet 20, agitator chamber 36, and exhaust 26 are all provided on the machine facing side of the mixing apparatus 10 and are insertable in a common e.g. horizontal direction. In some embodiments, the mixed powder outlet 24 and cleaning fluid drain 18, may be provided on a second side of the mixing apparatus 10. The first and second sides may be opposite to one another.

FIG. 5 shows a drink dispensing apparatus 500 in which the mixing apparatus 10 of the present disclosure may be used. The drink dispensing machine 500 may be any hot drinks machine such as a coffee, hot chocolate or soup vending machine for example, as noted above. The mixing apparatus 10 is located within a mixing apparatus housing 14 which comprises an enclosure in which the mixing apparatus 10 can be inserted and housed in use. The mixing apparatus housing 14 may comprise the ports which provide the various inlets and outlet for the mixing apparatus 10. Hence there is shown the powder inlet port 17, fluid inlet port 21 and agitator 23. Also shown are the connection points for the low-level mixed powder outlet 24, and cleaning fluid drain 18, which are connected respectively to pipes 24a and 18a. As noted above, the pipe 24a provides fluid communication with the outlet nozzle 42 and may include an isolating valve, which may be pinch valve 42, as show such that the mixing apparatus might be filled with cleaning fluid. The drainpipe 18a is connected to the external drain 40. The external drain 40 may be dedicated drain which is plumbed into a waste system such as a container or mains drain.

The outlet 24 may be configured to drain cleaning fluid from the mixing apparatus 10. The drain may be the outlet nozzle 46 or the external drain 40, or may be provided by the outlet nozzle 46 which provides the drained fluid to a drip tray or temporary drain placed under the outlet nozzle during a cleaning procedure. In some embodiments, the outlet nozzle may be temporarily connected to the external drain via a drainpipe 40′. The drainpipe 40′ may be provided by a temporary fluid collection device as described in WO2018/208156 which is incorporated herein by reference.

The exhaust system 52 may comprise a source of negative pressure, such as a fan 27′, which extracts air from the mixing apparatus 10.

The powder hopper 54 comprises a container in which powder can be stored and delivered to the powder inlet 16 of the mixing apparatus 10 via connecting a passageway. The passageway may comprise one or more valves 58 or other means for dispensing a predetermined amount of powder from the hopper 54 into the powder inlet 16 via the powder inlet port 17. In some embodiments, the hopper 54 may be directly connected to the dispensing apparatus 10, or the dispensing apparatus housing 14.

The cleaning fluid may be provided from a cleaning system 60. The cleaning system 60 may comprise a source of cleaning agent such as a detergent, however, as noted above, in some embodiments, the cleaning agent may comprise only steam or hot or cold water. As such, the cleaning system 60 may comprise a water heater and/or a source of water such as may be provided from a mains connection 66. The passageway 62 linking the cleaning system 60 to the cleaning fluid inlet 20′, may comprise a valve 64, so as to isolate the cleaning fluid from the mixing apparatus when not in use.

The mixing fluid inlet 20 may be in fluid communication with a fluid source (e.g. water) such as a mains connection 66 via passageway 68. The passageway 68 may incorporate a valve 70 and may connect with passageway 62 upstream of the mixing apparatus 10 such that only a single passageway is connected to the cleaning fluid inlet 20′/mixing fluid inlet 20.

The drink dispensing machine 500 may comprise a controller 72 which is configured to control the various parts of the drink dispensing machine 500 to allow drinks to be dispensed and cleaning processes to be undertaken upon instruction from a user. Thus, although not shown, the controller 72 connected to each of the elements of the drink machine 500 to allow the actuation and sensing needed during the preparation of a drink or a cleaning process. The controller 72, actuators and sensors provided at the various elements and lines of communication for sending and receiving commands or data to and from the sensors are conventional and well known in the art and not described in detail here.

The controller 72 may comprise a user interface. The user interface may be configured to receive instructions from a user and/or to provide a display for providing a user with information. The user interface may, for example, comprise an output display 74 and an input device 76 such as a touch screen input device or one or more buttons to enable a user to select options or operating the machine.

The controller 72 may be configured to allow a user to select a beverage type to dispense or to select a cleaning operation, for example, and/or be configured to providing levels of stock in the machine or the operating status, for example.

The controller 72 may comprise a timer and/or scheduler to allow cleaning operations to be carried out at specified times and/or according to a predetermined schedule. Thus, the controller 72 may be configured to carry out a cleaning operation automatically and without user interaction. Due to the configuration of the mixing apparatus 10, the user is not required to carry out any specific actions with regards to a cleaning operation of the mixing apparatus 10 and so cleaning can be scheduler in line with a preferred time of day or week.

It will be apparent to the skilled person that the drink dispensing machine 500 may include a number of other features which are conventional in the art. For example, the drink dispensing machine 500 may include a coffee brewer, water heater, coffee hopper, milk supply and milk frother etc.

In use, a user may insert the mixing apparatus 10 into the drink dispensing apparatus 500 and connect the various inlets and outlets. As noted above, the insertion of the mixing apparatus 10 require a vertical movement to mate the powder inlet port 17 and powder inlet 16 prior to rotating/swinging the mixing apparatus 10 toward the apparatus housing wall such that the fluid inlet 20 and fluid inlet port 21; the agitation chamber 36 and agitator 23; and exhaust 26 and exhaust port 27 can be connected in the horizontal direction. Once in situ, the pipes 18a and 24a can be connected (where required) following which the mixing apparatus 10 is ready for use.

As noted above, the drink dispensing machine 500 may comprise a controller which is configured to operate the mixing apparatus 10 when required. The operation of the mixing apparatus 10 include the starting of the exhaust system to extract air from the exhaust 26 whilst drawing air in via the inlet 28, depositing a predetermined amount of powder into the mixing chamber 12 via the powder inlet 16, introducing the mixing fluid via the fluid inlet 20 such that mixing can occur and the mixed powder exit the mixing chamber outlet 22 and flow into the agitator 23 for delivery to the drinking receptacle.

Following a predetermined number of uses or a predetermined duration, the controller may control the cleaning system to introduce cleaning fluid to the mixing chamber 12 via the cleaning fluid inlet 20′. The mixed powder outlet 24 may be closed whilst the cleaning fluid is introduced to the mixing chamber 12 such that it fills meet the cleaning fluid drain 18 where the spent cleaning fluid flows out to the external drain 40 or continues to another component in the cleaning circuit. Once a sufficient amount of cleaning fluid has been passed through the mixing chamber 12, or a predetermined amount of time has passed, the mixed powder outlet 24 (or a dedicated low-level drain) may be opened so as to drain the cleaning fluid which remains in the mixing chamber 12. The flow of cleaning fluid may be switched off to allow the fluid to be drained, or may be maintained to allow a continuous flow of cleaning fluid to pass through the mixing chamber and onwards through the pipework which constitutes the cleaning circuit or drain. The cleaning process may further include one or more rinse cycles in order to flush out any remaining cleaning fluid with clean water.

The mixing apparatus of the present disclosure may be readily installed within a drink dispensing machine by a user. In some embodiments, the positions of the inlets and outlets allow for the installation to be from a common direction. In some embodiments, providing the drain connections on an opposite side to the inlets and outlets may allow the drains to be connected following the insertion into the drink dispensing apparatus.

The mixing apparatus can be used in the preparation of one or more drinks. Further, the mixing apparatus can be cleaned without the need to be removed from the drink dispensing machine. Further still, the mixing apparatus may be cleaned without a user having to move or reconfigure the mixing apparatus. Thus, the need for user interaction with the mixing apparatus following the installation of the mixing apparatus allows cleaning to be automated.

Another advantage of the mixing apparatus of the present disclosure is the provision of an exhaust system and air inlet. Providing the air inlet around an edge of the mixing chamber wall and/or around the powder inlet allows an evacuating air flow to be created within the chamber to prevent fluid egress from the powder inlet and/or powder escaping from the mixing chamber in an uncontrolled manner. Further, providing the air inlet between an upper edge of the mixing chamber and an opposing surface of the mixing apparatus housing substantially encloses the internal volume of the mixing chamber. Providing an exhaust within the mixing chamber can create a positive airflow through the air inlet, e.g. the gap separating the chamber wall and mixing apparatus housing to minimise the escape of powder.

The mixing apparatus may comprise an agitator, however, it will be appreciated that this is optional and dependent on the type of beverage being prepared. Thus, in some embodiments, the mixing apparatus 10 may not comprise an agitator or agitation chamber and the mixing chamber outlet may be the mixed powder outlet (and optionally a low-level drain) of the mixing apparatus.

The one or more embodiments are described above by way of example only. Many variations are possible without departing from the scope of protection afforded by the appended claims.

1: A mixing apparatus for mixing a powder and a fluid for use in a drink dispensing machine, the mixing apparatus comprising:
a mixing chamber, wherein the mixing chamber comprises:
a powder inlet;
a cleaning fluid drain;
a fluid inlet; and,
a mixing chamber outlet for an outflow of mixed powder.

2: The mixing apparatus of claim 1, wherein the mixing chamber further comprises a chamber wall having a first base end and a second upper end, wherein at least one side wall extends upwardly between the base end and upper end, wherein the mixing chamber outlet is provided at the base end, and the powder inlet is provided towards the upper end.

3: The mixing apparatus of claim 1, wherein the cleaning fluid drain is located proximate to the powder inlet.

4: The mixing apparatus of claim 2, wherein the cleaning fluid drain comprises an aperture in the side wall.

5: The mixing apparatus of claim 2, wherein the cleaning fluid drain is located, with respect to vertical, between the powder inlet and the mixing chamber outlet.

6: The mixing apparatus of claim 5, wherein the fluid inlet is located between the cleaning fluid drain and the mixing chamber outlet.

7: The mixing apparatus of claim 1, wherein the cleaning fluid drain provides an overflow drain for cleaning fluid received and retained in the mixing chamber.

8. (canceled)

9: The mixing apparatus of claim 1, wherein the mixing chamber outlet is in fluid communication with a drain via a passageway for draining cleaning fluid, wherein the passageway comprises an isolating valve.

10-11. (canceled)

12: The mixing apparatus of claim 1 further comprising an agitator chamber downstream of the mixing chamber outlet.

13: The mixing apparatus of claim 1, wherein the fluid inlet is configured to receive a mixing fluid for mixing with the powder and a cleaning fluid for filling the mixing chamber during a cleaning procedure.

14: The mixing apparatus of claim 1 further comprising an air inlet.

15: The mixing apparatus of claim 1 further comprising an exhaust for evacuating air from the mixing chamber.

16: The mixing apparatus of claim 15, wherein the exhaust is connectable to a source of negative air pressure to provide an air flow from the mixing chamber.

17: The mixing apparatus of claim 15, wherein the exhaust comprises the cleaning fluid drain.

18: The mixing apparatus of claim 14 wherein the powder inlet is provided radially inwardly of the air inlet.

19-22. (canceled)

23: The mixing apparatus of claim 1, wherein the powder inlet is provided by an open end of the mixing chamber, and wherein the open end is configured to receive a powder inlet chute of the drink dispensing machine.

24: The mixing apparatus of claim 2, wherein the fluid inlet comprises a fluid inlet passageway which extends tangentially through the side wall.

25: A drink dispensing machine comprising the mixing apparatus according to claim 1.

26: A method of cleaning a mixing apparatus in a drink dispensing machine, comprising:
operably inserting the mixing apparatus into the drink dispensing machine;
filling the mixing chamber with cleaning fluid up to the cleaning fluid drain; and,
allowing the cleaning fluid to drain from the cleaning fluid drain.

27: The method of claim 26, wherein the cleaning fluid drain is an overflow drain.
